(19) United States
(12) Patent Application Publication
(10) Pub. No.: US 2014/0102313 A1
(43) Pub. Date: Apr. 17, 2014

(54) Popcorn Making Machine with Various Configurations of Roaster

(71) Applicant: Mikhail Korin, Moscow (RU)

(72) Inventor: Mikhail Korin, Moscow (RU)

(21) Appl. No.: 13/653,587

(22) Filed: Oct. 17, 2012

(51) Int. Cl. A23L 1/18

(52) U.S. Cl. 99/323.9

(57) ABSTRACT

A popcorn making machine is proposed in three embodiments including a roaster, provided with a circulated hot airflow, and a pipebranch coupled thereto, receiving popcorn from the roaster and discharging thereof. In the first embodiment, the roaster has truncated conical sidewalls, the pipebranch has a rectangular cross-section. In the second embodiment the roaster is configured as at least a portion of a deformed sphere having a lesser pole radius and a greater equator radius, the pipebranch is conjugated with the roaster without any acute angle, and continuously tapers transforming into a cylindrical shape. In the third preferred embodiment, the roaster and pipebranch are similar to the ones of the second embodiment, but the roaster additionally contains a central cavity configured in a cone-like shape, having a base, a cupola-like top, and a curved conjugation angle at the base. The aforementioned shapes reduce manufacturing costs and improve the popcorn machine's productivity.

### FIELD OF THE INVENTION

This invention relates to corn popping machines, particularly to popcorn preparation machines utilizing the continuous popping of corn kernels by means of a hot airflow.

### BACKGROUND OF THE INVENTION

There are known a variety of devices for popcorn processing, for example, the one taught in U.S. Pat. No. 7,024,986 that describes “a popcorn maker including a self-regulating heating unit. The self-regulating heating unit provides a regulated heat to the popcorn maker. The self-regulating heating unit can be configured to maintain a predetermined temperature for the popcorn maker. The predetermined temperature can be adjusted to provide appropriate amount of heat to the popcorn maker for popping a maximum number of corn kernels while limiting the heat from causing damage to heating coils and thermoplastic parts of the popcorn maker. The self-regulating heating unit includes a positive temperature coefficient heater.”

Another U.S. Pat. No. 5,421,253 teaches a ‘convection oven corn popper and method’ that “. . . is provided to air-pop popcorn in combination with a convection-type oven. The device comprises a spring-mounted bowl to hold corn kernels and includes a slot in the sidewall for popped popcorn to exit therefrom. The exiting popcorn falls into the cooking chamber of the oven where it is held warm until ready to eat.”

“A portable heat-concentrating kettle cooker” is taught in U.S. Pat. No. 6,234,064, in particular, having “a housing with a burner supported within the housing and a kettle carrier pivotably attached to a top edge of the housing such that it can be pivoted from a substantially horizontal position across the top of the housing to a substantially vertical position. The kettle carrier includes a cooking kettle that is positioned over the burner when the kettle carrier is in its substantially horizontal position, and when the kettle carrier is in its substantially vertical position, the cooker kettle is positioned to empty its contents into a tub that is supported next to the housing by a detachable frame extending from the housing. Additional features of the cooker include a heat intensification chamber formed by a wall around the burner in order to redirect radiant energy from the burner back into the heat intensification chamber. A cooking oil receptacle is also detachably mounted to the housing. Fuel supplied to the heater can be natural gas, propane, or electricity, with fuel supply lines passing through a fuel supply/control chamber at the front of the housing and fuel regulating controls positioned on the front of the housing.”

U.S. Pat. No. 6,187,353 to Wyman et al teaches “a hot air popcorn machine including a programmable control system for precisely controlling various operating parameters including air flow and air temperature to enable the machine to consistently produce high quality popcorn in a low maintenance environment, e.g., a free-standing vending machine.” In Wyman's machine, hot airflow comes through the kernels and exits the cooking chamber, i.e. the hot airflow is not confined in the machine. This leads to over-drying popcorn and overpaying for electric power.

U.S. Pat. No. 6,460,451 to Helman et al discloses “A popcorn maker, which utilizes a combination of popping means, and converts corn kernels to popped corn quicker, more efficiently, and with improved taste. The popcorn maker uses a combination of roasting, agitation, heating, and convection to convert the corn kernels into the popcorn, and expel the popcorn out of the popcorn maker. The popcorn maker is easy to use, the corn kernels and the popcorn easily viewable and fun to watch during popping, the popcorn maker producing the popcorn in a quick, convenient, and efficient manner. The popcorn maker discharges the popcorn from a convenient discharge chute into a receptacle of choice, resembles, and has the appearance of an old fashioned popcorn maker. The popcorn maker is free standing, easy to clean and maintain, and of long lasting, durable material. The popcorn maker is light weight, inexpensive, safe to use, attractive, sturdy, of simple construction., and is easy to store.” In Helman's popcorn maker, hot airflow also comes through the kernels and exits the roaster, i.e. the hot airflow is not confined in the machine. This leads to over-drying popcorn and overpaying for electric power.

U.S. Pat. No. 4,727,798 issued to Nakamura (herein further called ‘Nakamura’) discloses a “popcorn processing machine has a heating chamber into which a measured quantity of raw corn kernels are fed in each operational cycle to be heated, agitated, and thus popped by only a hot air supplied under pressure as a whirling rising vortex, without the use of an oil, whereby greatly expanded puffs of popcorn of uniform quality are produced in a high yield and in a short processing time. The bottom of the heating chamber can be opened by a simple mechanism, whereby the popped popcorn product can be quickly dumped and the chamber bottom rapidly reclosed, the operational cycle time thereby being extremely short.”

Designers of popcorn making machines often encounter a common problem particularly described in Nakamura: “In a typical popcorn processing machine known heretofore, a receiving dish or pan into which corn kernels are charged is provided above a heat source. At the bottom of this pan, agitator vanes for rotating along the upper surface of the pan bottom are fixedly supported on a vertical shaft. Accordingly, when the vertical shaft is rotated, the vanes rotate within the pan thereby to agitate the raw corn kernels as they are heated by the heat source, whereby the corn kernels are heated and popped into expanded state to fill the interior of the pan. In such a machine, oil is ordinarily placed in the pan in order to cause the raw corn kernels to pop rapidly. As a consequence of the agitation of the corn kernels, this oil tends to be scattered together with minute particles of the corn against the inner surface of a transparent cover installed for observation around the sides of the pan. The oil and corn particles thus adhere to the glass cover, thereby dirtying the glass and causing it to become opaque. Furthermore, if these contaminants are left in adhering state, they will attract undesirable insects such as cockroaches and are therefore very unhygienic. Since an opaque condition of the glass cover prevents or obstructs observation of the corn popping progress, the contaminants must be frequently wiped off by hand, which is an inconvenient task. However, if oil is not used in order to prevent this contamination, the time for popping the raw corn becomes disadvantageously long. Furthermore, the construction of the machine itself in this case has been complicated because of the necessity of providing rotational support means and driving means for the agitator vanes.”

As shown above, Nakamura solves this problem by supplying “a hot air supplied under pressure as a whirling rising vortex, without the use of an oil” into the heating chamber with an openable bottom for popping. Thereafter, “the popped popcorn product can be quickly dumped and the chamber bottom rapidly reclosed, the operational cycle time thereby being extremely short.” However, the “whirling rising vortex” conditions an increased density of kernels in the lower central region of the chamber, wherein the speed of kernels and temperature of hot air are essentially minimal, which leads to uneven heating the kernels located in this region that slows down the overall heating of corn kernels in the chamber thereby decelerating the whole process of popcorn preparation. Besides, the movable bottom of the heating chamber reduces the overall reliability and maintainability of the Nakamura's machine.

The aforementioned shortage of Nakamura's machine was addressed in U.S. patent application 12/592,106 filed on 18 Nov. 2009 by Mikhail Korin, the instant inventor, now U.S. Pat. No. 8,276,504 issued on 2 Oct. 2012, titled “Hot-air popcorn machine especially with a seasoning coater”, whose disclosure is incorporated herein in its entirety by reference. U.S. Pat. No. 8,276,504 particularly teaches “A popcorn making machine includes a main unit comprising a fan pumping air into a chamber, enclosing a heater and a bowl. The bowl has sidewalls tapered downwardly with mini-nozzles attached thereto. Hot airflows are introduced from the chamber through the mini-nozzles into the bowl tangentially to its inner surface, forming a main hot airflow circulation. A central nozzle is mounted at the bowl's bottom, including slots, introducing additional airflows, tangential to the nozzle's surface, from the chamber into the bowl, forming an additional hot airflow circulation surrounding the nozzle, co-directed with the main circulation . . . ” This popcorn making machine is advantageous, since it provides a circulated hot airflow confined within the cooking chamber, which improves the popcorn preparation process and recycles heat. Nonetheless, exploitation and maintenance of the popcorn machine according to U.S. Pat. No. 8,276,504 have revealed certain inconveniences.

Firstly, it was proven experimentally, that the hot airflow circulation can sufficiently be provided even without the central nozzle, which can reduce expenses for manufacturing the popcorn making machine. Secondly, it's appeared that the popcorn making process in the machine can be made smoother and a percentage of wasted corn kernels can be significantly reduced by changing the shape of a roaster (it was called ‘a heating bowl’ in U.S. Pat. No. 8,276,504) and the shape of a pipebranch (it was called ‘an intermediate pipe’ in U.S. Pat. No. 8,276,504) receiving popped up corn kernels from the roaster.

### BRIEF SUMMARY OF THE INVENTION

Therefore, one aim of the claimed invention is to simplify the design of hot-air popcorn making machine and reduce the costs for manufacturing thereof.

Another aim of the claimed invention is to the reduce the percentage of corn kernels that was wasted in the machine taught in to U.S. Pat. No. 8,276,504.

Another aim of the claimed invention is to utilize optional embodiments of the popcorn making machine, according to U.S. Pat. No. 8,276,504, including the employment of a coater unit for coating the popped corn with oil, salt, etc.

Other aims and particular applications of the claimed invention may become apparent to one skilled in the art upon learning the present disclosure.

These aims are achieved by providing at least three preferred embodiments of the popcorn making machine, according to the present invention.

In the first preferred embodiment, the popcorn making machine comprises: a case; a roaster mounted within the case, said roaster has an upper opening and sidewalls having a truncated conical surface; the roaster is supplied with raw corn kernels; a circulated hot airflow is provided within the roaster, such that the raw corn kernels pop up in the roaster; and a pipebranch coupled to the upper opening of the roaster; the pipebranch receives popped up corn kernels from the roaster; the pipebranch tapers such that having a rectangular cross section being continuously narrower than the upper opening of the roaster; the pipebranch includes a first inclined branch receiving popped-up corn kernels from the roaster, and a second inclined branch in a knee-manner joined with the first inclined branch, wherein corn kernels popped-up in the roaster are discharged from the second inclined branch.

In the second preferred embodiment, the popcorn making machine comprises: a case; a roaster mounted within the case, said roaster has an upper opening and sidewalls; the roaster is supplied with raw corn kernels; a circulated hot airflow is provided within the roaster, such that the raw corn kernels pop up in the roaster; the roaster is configured as at least a portion of a deformed sphere, the sphere has a pole radius and an equator radius, wherein the pole radius is less than the equator radius; a pipebranch receiving popped up corn kernels from the roaster and discharging thereof from the popcorn making machine, the pipebranch is conjugated with the upper opening of the roaster without any acute angle, the pipebranch continuously tapers in the direction from the upper opening of the roaster, such that it transforms into a cylindrical shape.

In the third preferred embodiment, the popcorn making machine comprises: a case; a roaster mounted within the case, said roaster has an upper opening, a bottom with a center, and sidewalls; the roaster is supplied with raw corn kernels; a circulated hot airflow is provided within the roaster, such that the raw corn kernels pop up in the roaster; the roaster is configured as at least a portion of a deformed sphere, the deformed sphere has a pole radius and an equator radius, wherein the pole radius is less than the equator radius; the roaster contains a central cavity having a curved cone-like shape with a base having a base center substantially positioned in the center of the bottom of the roaster, a cupola-like top, and a curved conjugation angle at the base of said central cavity; and a pipebranch receiving popped up corn kernels from the roaster and discharging thereof from the popcorn making machine, the pipebranch is conjugated with the upper opening of the roaster without any acute angle, the pipebranch continuously tapers in the direction from the upper opening of said roaster, such that it transforms into a cylindrical shape.

### BRIEF DESCRIPTION OF DRAWINGS

FIG. 1 shows a sectional front view of the popcorn making machine with a roaster having a bottom and sidewalls tapered downwards, according to a first preferred embodiment of claimed invention.

FIG. 2 shows a sectional lateral view of the popcorn making machine, according to the first preferred embodiment of claimed invention depicted on FIG. 1.

FIG. 3 shows a sectional front view of the popcorn making machine with an “onion-shaped” roaster, according to a second preferred embodiment of claimed invention.

FIG. 4 shows a sectional front view of the popcorn making machine with a roaster having an “onion-like” shape with a central cavity having a curved cone-like shape with a base, a cupola-like top and a curved conjugation angle at the base thereof, according to a third preferred embodiment of claimed invention.

FIG. 5 shows an isometric view of the roaster, designed according to the first preferred embodiment of claimed invention.

FIG. 6 shows an isometric view of the roaster, designed according to the second preferred embodiment of claimed invention.

FIG. 7 shows an isometric view of the roaster, designed according to the third preferred embodiment of claimed invention.

### DETAIL DESCRIPTION OF PREFERRED EMBODIMENTS OF THE INVENTION

While the invention may be susceptible to embodiment in different forms, there are shown in the drawings, and will be described in detail herein, specific embodiments of the present invention, with the understanding that the present disclosure is to be considered an exemplification of the principles of the invention, and is not intended to limit the invention to that as illustrated and described herein.

### First Preferred Embodiment

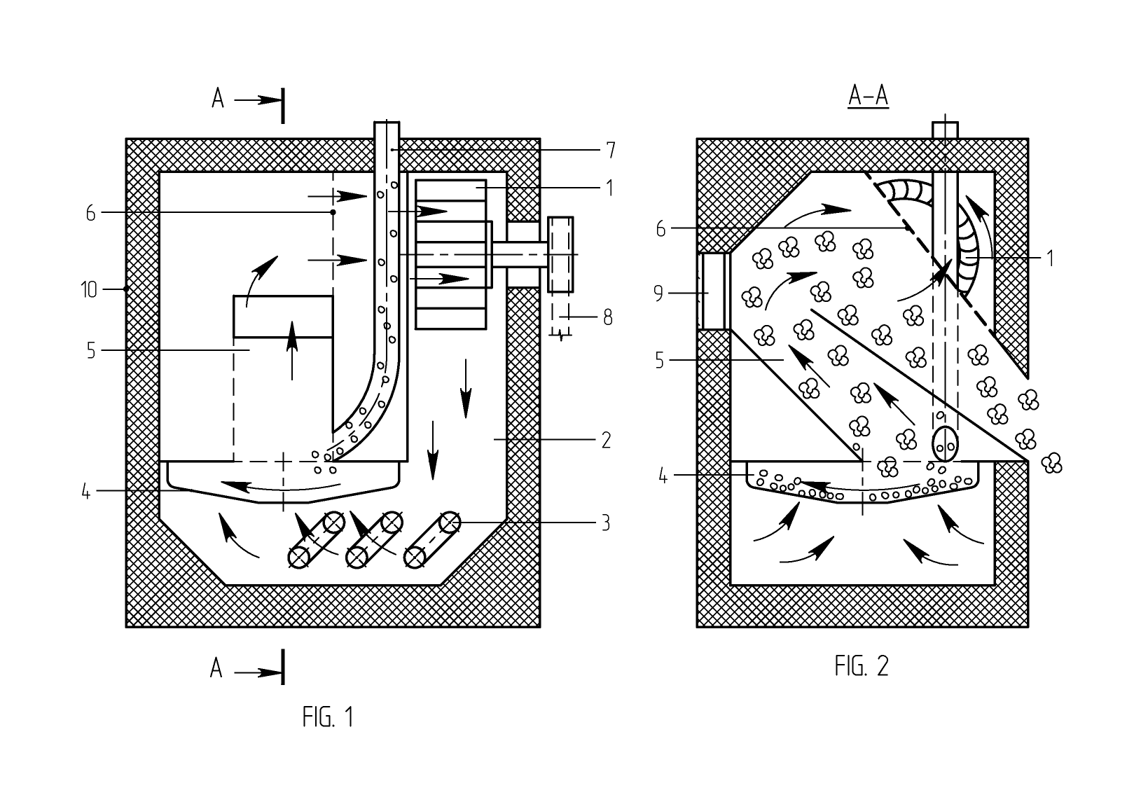

In a first preferred embodiment, illustrated on FIGS. 1, 2 and 5, the inventive popcorn making machine includes a main unit 100 comprising: a case 2 with a top lid and a bottom; a fan 1 driven by a drive 8 (that may preferably include an electric motor—not shown, and a transmission, for example, a belt transmission); the fan 1 is capable of pumping air via a net screen 6 inside the case 2 that encloses a roaster 4 (can also be called a ‘kettle’ or a ‘cooker’), and a heater 3 that can be represented by any suitable type of conventional heater, preferably an electric coil outwardly surrounding the roaster's sidewalls (as shown on FIG. 1), and powered preferably from a suitable electrical source, not shown herein, preferably supplying controllable voltage. The heater 3 is preferably mounted at the heating chamber's bottom, beneath the roaster 4. The net screen 6 prevents getting popped up corn kernels to the fan 1.

The roaster 4 has an upper opening, a bottom, and sidewalls having a truncated conical surface that are tapered downwardly (i.e. shaped similar to that of U.S. Pat. No. 8,276,504). The sidewalls are preferably furnished with mini-nozzles (not shown) attached to the internal surface of sidewalls. The mini-nozzles can be attached to the bottom of roaster 4 as well. The mini-nozzles may have a shape described in U.S. Pat. No. 8,276,504, or another similar shape, suitable for creation of a circulated airflow within the roaster 4. Thusly, hot airflows are introduced from the interior of case 2, preferably through the mini-nozzles, into the roaster 4 tangentially to the inner surface of its sidewalls, thereby forming a hot airflow circulation within the roaster 4. Raw corn kernels, effected by the hot airflow circulation, are popped up. Optionally, the hot airflow circulation can be provided not necessarily by mini-nozzles, but by other means capable of creating such hot airflow circulation.

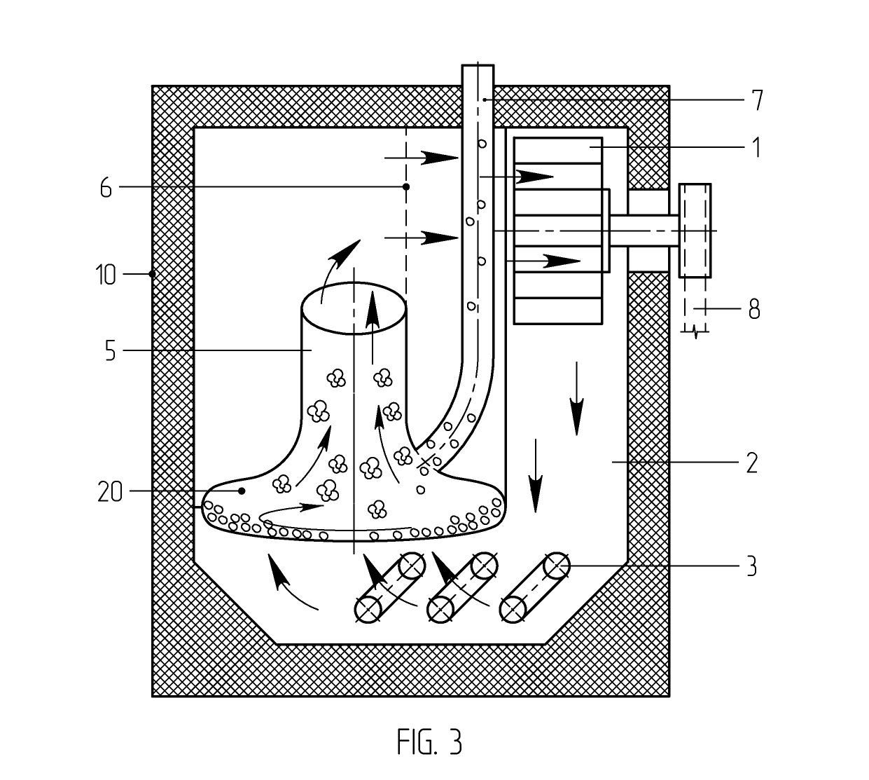

In the first preferred embodiment, the main unit 100 comprises a feeding pipe 7 supplying raw corn kernels into the roaster 4. The feeding pipe 7 is mounted preferably vertically in the top lid for intake of raw corn kernels and further introducing thereof substantially into the roaster 4. The raw corn is popped up in the roaster 4, and the popped up corn kernels are drawn by the circulated airflow into a pipebranch 5, preferably having a rectangular cross section, which is coupled with the upper opening of roaster 4, and narrows from the upper opening of roaster 4. The pipebranch 5 preferably includes a first inclined branch receiving popped-up corn kernels from the roaster 4, and a second inclined branch in a ‘knee’-manner joined with the first inclined branch, through which second inclined branch the popped-up corn kernels are discharged from the main unit 100, as shown on FIG. 2. An optional transparent window 10, as shown on FIG. 2, can preferably be provided in the main unit 100, which allows observing the process of making popcorn.

### Second Preferred Embodiment

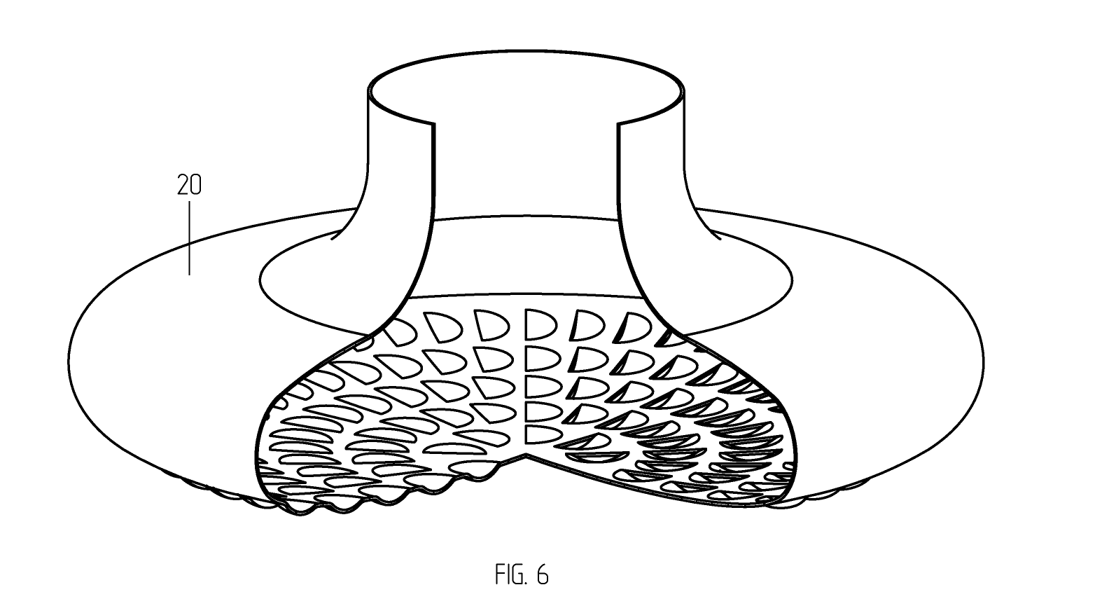

The second preferred embodiment of the inventive popcorn making machine has a design (illustrated on FIGS. 3 and 6) similar to the first one described above, except for the shapes of roaster and pipebranch. In the second preferred embodiment, the inventive popcorn making machine includes a main unit 100 comprising: a case 2 with a top lid and a bottom; a fan 1 driven by a drive 8 (that may preferably include an electric motor—not shown, and a transmission, for example, a belt transmission); the fan 1 is capable of pumping air via a net screen 6 inside the case 2 that encloses a roaster 20 (can also be called a ‘kettle’ or a ‘cooker’), and a heater 3 that can be represented by any suitable type of conventional heater, preferably an electric coil outwardly surrounding the roaster's sidewalls (as shown on FIG. 3), and powered preferably from a suitable electrical source, not shown herein, preferably supplying controllable voltage. The heater 3 is preferably mounted at the case's bottom, beneath the roaster 20. The net screen 6 prevents getting popped up corn kernels to the fan 1.

The roaster 20 has an upper opening, a bottom, and sidewalls, and is configured similar to an ‘onion-like’ shape (as illustrated on FIGS. 3 and 6). In other words, the roaster 20 is configured as at least a portion of a deformed sphere having its pole radius less than the equator radius. The sidewalls are preferably furnished with mini-nozzles (not shown) attached to the internal surface of sidewalls. The mini-nozzles can be attached to the bottom of roaster 20 as well. The mini-nozzles may have a shape described in U.S. Pat. No. 8,276,504, or another similar shape, suitable for creation of a circulated airflow within the roaster 20. Thusly, hot airflows are introduced from the interior of case 2, preferably through the mini-nozzles, into the roaster 20 tangentially to the inner surface of its sidewalls, thereby forming a hot airflow circulation within the roaster 20. Raw corn kernels, effected by the hot airflow circulation, are popped up. Optionally, the hot airflow circulation can be provided not necessarily by mini-nozzles, but by other suitable means capable of creating such hot airflow circulation.

In the second preferred embodiment, the main unit 100 comprises a feeding pipe 7 supplying raw corn kernels into the roaster 20. The feeding pipe 7 is mounted preferably vertically in the top lid for intake of raw corn kernels and further introducing thereof substantially into the roaster 20. The raw corn is popped up in the roaster 20, and the popped up corn kernels are drawn by the circulated airflow into a pipebranch 5. The pipebranch 5 has a circular cross section continuously becoming less than the upper opening of roaster 20; i.e. the pipebranch 5 tapers in the direction from the upper opening of the roaster 20, such that it is smoothly transforming into a cylindrical shape. The narrowing shape of pipebranch 5 provides for fast drawing of popped up corn kernels from the roaster. The upper opening of roaster 20 is smoothly conjugated with the pipebranch 5, without any acute angle. The pipebranch 5 preferably includes a first inclined branch receiving popped-up corn kernels from the roaster 20, and a second inclined branch in a ‘knee’-manner joined with the first inclined branch, through which second inclined branch the popped-up corn kernels are discharged from the main unit 100. Such design provides for absence of acute angles, which in turn reduces damage of popped up corn kernels while encountering the walls of roaster 20.

### Third Preferred Embodiment

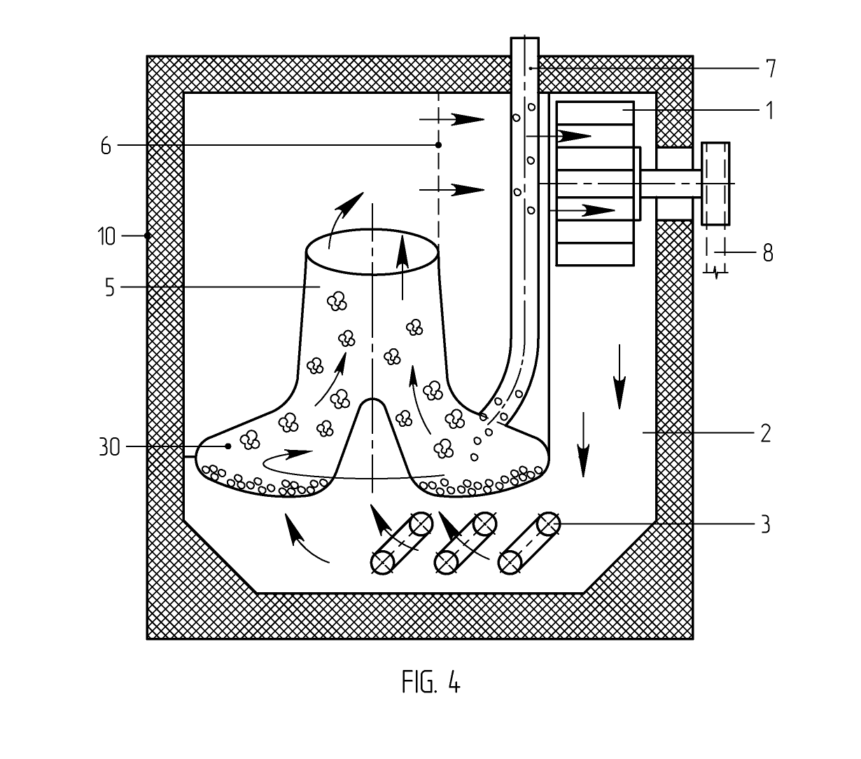

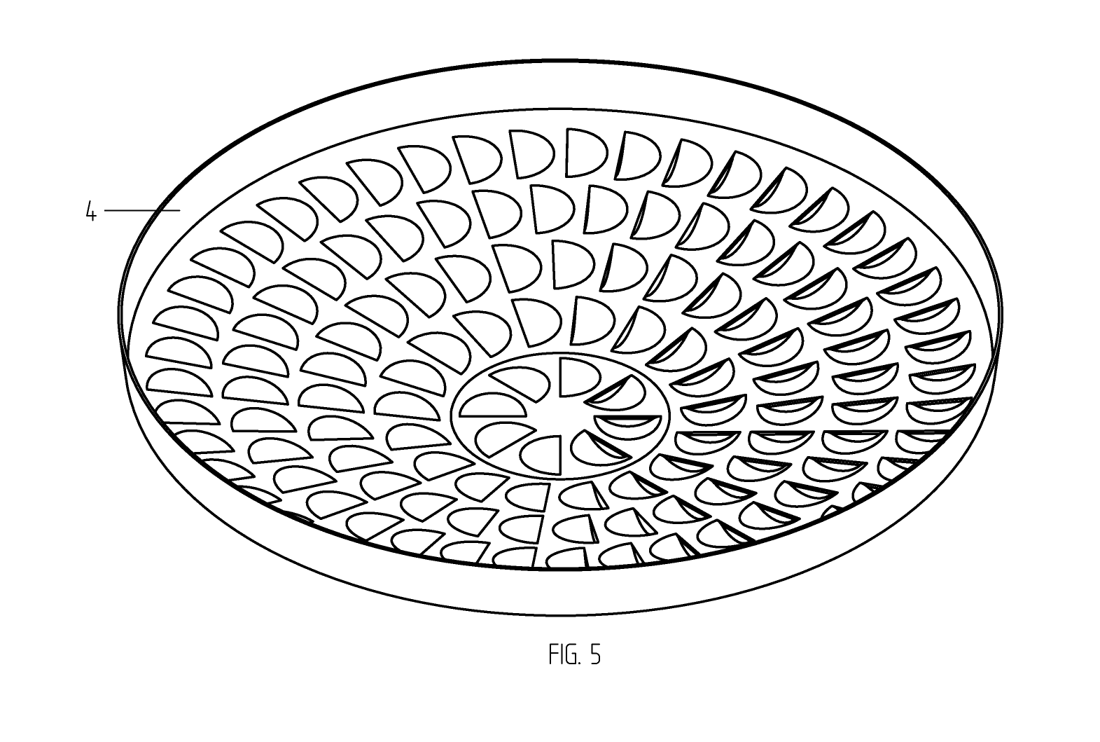

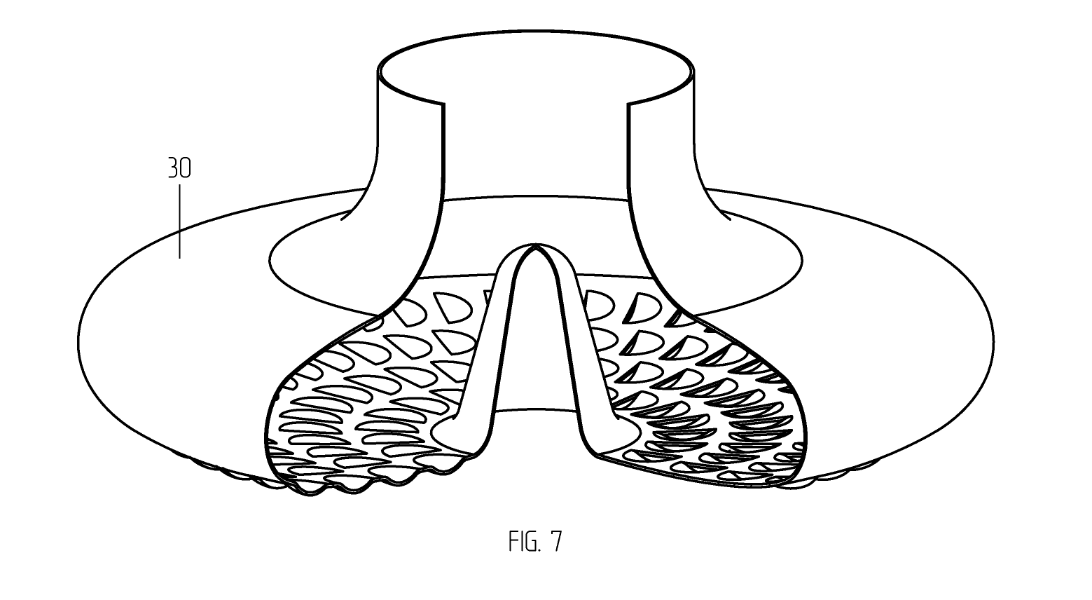

The third preferred embodiment of the inventive popcorn making machine has a design (illustrated on FIGS. 4 and 7) similar to the first one described above, except for the shapes of roaster and pipebranch. In the third preferred embodiment, the inventive popcorn making machine includes a main unit 100 comprising: a case 2 with a top lid and a bottom; a fan 1 driven by a drive 8 (that may preferably include an electric motor—not shown, and a transmission, for example, a belt transmission); the fan 1 is capable of pumping air via a net screen 6 inside the case 2 that encloses a roaster 30 (can also be called a ‘kettle’ or a ‘cooker’), and a heater 3 that can be represented by any suitable type of conventional heater, preferably an electric coil outwardly surrounding the roaster's sidewalls (as shown on FIG. 4), and powered preferably from a suitable electrical source, not shown herein, preferably supplying controllable voltage. The heater 3 is preferably mounted at the case's bottom, beneath the roaster 30. The net screen 6 prevents getting popped up corn kernels to the fan 1.

The roaster 30 has an upper opening, a bottom, and sidewalls, and is configured similar to an ‘onion-like’ shape, but with a central cavity (as illustrated on FIGS. 4 and 7). In other words, the roaster 30 is configured as at least a portion of a deformed sphere having its pole radius less than the equator radius, which deformed sphere contains a central cavity, while the central cavity has a curvilined cone-like shape with a base, positioned on the bottom of roaster 30, a cupola-like top, and a curved conjugation angle at the base thereof. The sidewalls of roaster 30 are preferably furnished with mini-nozzles (not shown) attached to the internal surface of sidewalls. The mini-nozzles can be attached to the bottom of roaster 30 as well. The mini-nozzles may have a shape described in U.S. Pat. No. 8,276,504, or another similar shape, suitable for creation of a circulated airflow within the roaster 30. Thusly, hot airflows are introduced from the interior of case 2, preferably through the mini-nozzles, into the roaster 30 tangentially to the inner surface of its sidewalls, thereby forming a hot airflow circulation within the roaster 30. Raw corn kernels, effected by the hot airflow circulation, are popped up. Optionally, the hot airflow circulation can be provided not necessarily by mini-nozzles, but by other means capable of creating such hot airflow circulation.

In the third preferred embodiment, the main unit 100 comprises a feeding pipe 7 supplying raw corn kernels into the roaster 30. The feeding pipe 7 is mounted preferably vertically in the top lid for intake of raw corn kernels and further introducing thereof substantially into the roaster 30. The raw corn is popped up in the roaster 30, and the popped up corn kernels are drawn by the circulated airflow into a pipebranch 5. The pipebranch 5 has a circular cross section continuously becoming less than the upper opening of roaster 30; i.e. the pipebranch 5 tapers in the direction from the upper opening of the roaster 30, such that it is smoothly transforming into a cylindrical shape. The narrowing shape of pipebranch 5 provides for fast drawing of popped up corn kernels from the roaster. The upper opening of roaster 30 is smoothly conjugated with the pipebranch 5, without any acute angle. The pipebranch 5 preferably includes a first inclined branch receiving popped-up corn kernels from the roaster 30, and a second inclined branch in a ‘knee’-manner joined with the first inclined branch, through which second inclined branch the popped-up corn kernels are discharged from the main unit 100. Such design provides for absence of acute angles, which in turn reduces damage of popped up corn kernels while encountering the walls of roaster 30. Additionally, the central cavity enhances the circulation of hot airflow in the roaster, which accelerates the popcorn making process and improves the quality of popcorn.

OPTIONAL RAMIFICATIONS

As it was disclosed in U.S. Pat. No. 8,276,504: “In addition to the main unit 100, a preferred (combined) embodiment of the inventive popcorn making machine . . . may additionally comprise a coater unit . . . The claimed popcorn making machine in alternative embodiments may comprise only the above described main unit 100 without any coater unit.” Likewise, the main unit 100 of the instant invention can also be optionally combined with the coater unit described in U.S. Pat. No. 8,276,504.

I claim:

1. A popcorn making machine comprising:
a case;
a roaster mounted within said case, said roaster has an upper opening and sidewalls having a truncated conical surface tapered downwardly; the roaster is supplied with raw corn kernels; a circulated hot airflow is provided within said roaster, such that the raw corn kernels pop up in the roaster; and
a pipebranch coupled to the upper opening of said roaster; said pipebranch receives popped up corn kernels from the roaster; said pipebranch tapers such that having a rectangular cross section being continuously narrower than the upper opening of said roaster; the pipebranch includes a first inclined branch receiving popped-up corn kernels from the roaster, and a second inclined branch in a knee-manner joined with the first inclined branch, wherein corn kernels popped-up in said roaster are discharged from the second inclined branch.

2. A popcorn making machine comprising:
a case;
a roaster mounted within said case, said roaster has an upper opening and sidewalls; the roaster is supplied with raw corn kernels; a circulated hot airflow is provided within said roaster, such that the raw corn kernels pop up in the roaster; said roaster is configured as at least a portion of a deformed sphere, the sphere has a pole radius and an equator radius, wherein the pole radius is less than the equator radius;
a pipebranch receiving popped up corn kernels from said roaster and discharging thereof from the popcorn making machine, said pipebranch is conjugated with the upper opening of said roaster without any acute angle, the pipebranch continuously tapers in the direction from the upper opening of said roaster, such that the pipebranch transforms into a cylindrical shape.

3. A popcorn making machine comprising:
a case;
a roaster mounted within said case, said roaster has an upper opening, a bottom with a center, and sidewalls; the roaster is supplied with raw corn kernels; a circulated hot airflow is provided within said roaster, such that the raw corn kernels pop up in the roaster; said roaster is configured as at least a portion of a deformed sphere, the deformed sphere has a pole radius and an equator radius, wherein the pole radius is less than the equator radius; said roaster contains a central cavity having a curvilined cone-like shape with a base, said central cavity having:
a base center substantially positioned in the center of said bottom of the roaster,
a cupola-like top, and
a curved conjugation angle at the base of said central cavity; and
a pipebranch receiving popped up corn kernels from said roaster and discharging thereof from the popcorn making machine, said pipebranch is conjugated with the upper opening of said roaster without any acute angle, the pipebranch continuously tapers in the direction from the upper opening of said roaster, such that the pipebranch transforms into a cylindrical shape.
